(19) United States
(12) Patent Application Publication
(10) Pub. No.: US 2018/0173219 A1
(43) Pub. Date: Jun. 21, 2018

(54) SYSTEMS AND METHODS FOR OPTIMIZING ENERGY CONSUMPTION IN AUTONOMOUS VEHICLES

(71) Applicant: Faraday&Future Inc., Gardena, CA (US)

(72) Inventors: Dong Ryeol Lee, San Jose, CA (US); Sangmin Oh, Santa Clara, CA (US)

(21) Appl. No.: 15/719,834

(22) Filed: Sep. 29, 2017

Related U.S. Application Data
(60) Provisional application No. 62/402,777, filed on Sep. 30, 2016.

(51) Int. Cl. G05D 1/00; G01C 21/34

(52) U.S. Cl. CPC G05D 1/0005; G05D 1/0088; G01C 21/3469; B60W 30/182; G01C 21/3446; G05D 2201/0213; G01C 21/3492

(57) ABSTRACT

A system that performs a method is disclosed. The system receives a desired destination and detects one or more energy characteristics about one or more batteries via one or more sensors. The system determines a current location of a vehicle via the one or more sensors, one or more possible routes to the desired destination, and route energy requirements for each of the one or more possible routes. The system then selects one or more routes based on the one or more energy characteristics about the one or more batteries and the route energy requirements.

### CROSS-REFERENCE TO RELATED APPLICATIONS

This application claims the benefit of U.S. Provisional Application No. 62/402,777, filed Sep. 30, 2016, the entirety of which is hereby incorporated by reference.

### FIELD OF THE DISCLOSURE

The various embodiments of the present invention relate generally to optimizing energy consumption in vehicles.

### BACKGROUND OF THE DISCLOSURE

Electronic vehicles are increasingly becoming more popular, and the deployment of autonomous driving technology continues to grow. However, compared to traditional vehicles, autonomous and semi-autonomous vehicles require more energy to monitor and control. A solution to optimize energy consumption in autonomous and semi-autonomous vehicles is desirable.

### SUMMARY OF THE DISCLOSURE

Examples of the disclosure are directed to optimizing energy consumption in autonomous and semi-autonomous vehicles. The vehicle can select a route to a desired destination from one or more possible routes based on the amount of energy required for each route. To accomplish this, the vehicle can use a map that is portioned into segments that each contain the amount of energy required for the vehicle to travel along that segment. The vehicle can then determine what combination of one or more segments will require the least amount of energy for the vehicle to reach its desired destination. The vehicle can also adjust the operation of one or more vehicle components based on the type of environment that the vehicle is in, the vehicle's speed, the traffic around the vehicle, route information, and/or energy characteristics about the vehicle.

### BRIEF DESCRIPTION OF THE DRAWINGS

FIG. 1 illustrates an exemplary system block diagram of a vehicle control system according to examples of the disclosure.

FIG. 2 illustrates an exemplary vehicle determining two possible routes using a map according to examples of the disclosure.

FIG. 3 illustrates an exemplary process for determining one or more routes based on vehicle energy characteristics and estimated energy requirements according to examples of the disclosure.

FIG. 4 illustrates an exemplary process for planning a route according to examples of the disclosure.

FIG. 5 illustrates an exemplary process for adjusting the operation of vehicle components to conserve energy according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to either autonomous driving, partially autonomous driving, and/or driver assistance systems.

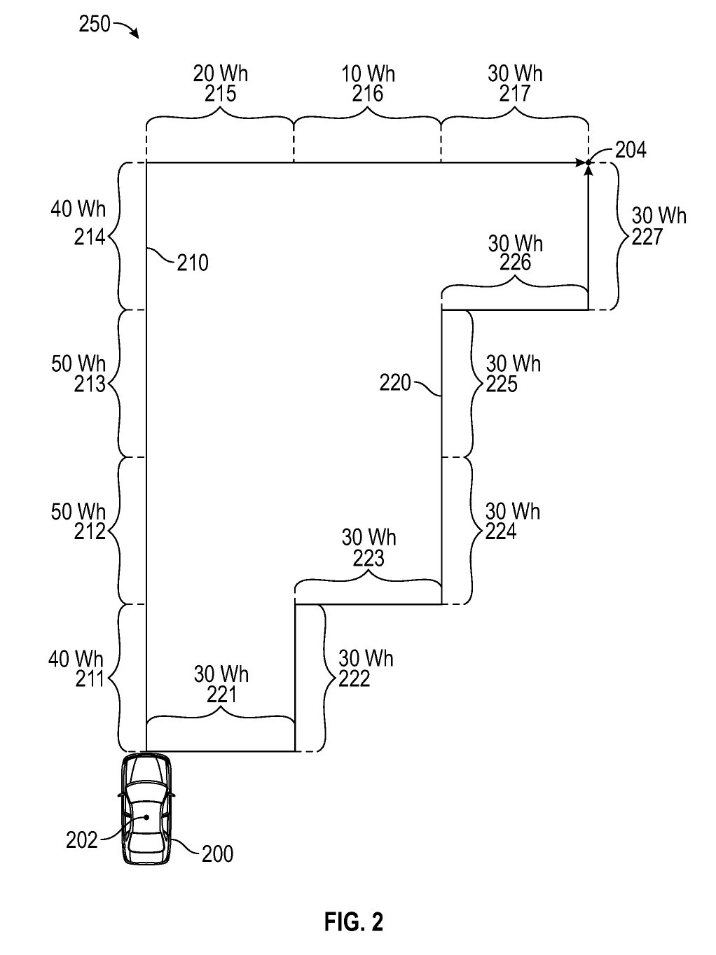

Autonomous and semi-autonomous vehicles, such as automobiles, may be constantly processing and monitoring data from various sensors on or around the vehicle. Thus, more energy may be required to operate an autonomous or semi-autonomous vehicle than traditional vehicles. Further, in some cases, when semi-autonomous or manual driving, some energy can be wasted due to a driver's actions and traffic attributes. In cases where semi-autonomous or manual driving are implemented, an efficiency multiplier can be computed based on trip attributes and update an amount of energy that should be used based on various vehicle attributes. Thus, examples as shown in FIG. 2 may be different for drivers when using semi-autonomous modes.

Examples of the disclosure are directed to optimizing energy consumption in autonomous and semi-autonomous vehicles. The vehicle can select a route to a desired destination from one or more possible routes based on the amount of energy required for each route. To accomplish this, the vehicle can use a map that is portioned into segments that each contain the amount of energy required for the vehicle to travel along that segment. For each segment, an ideal amount of energy to be used can be computed based on the physics of the terrain and the overall vehicle weight. The vehicle can then determine what combination of one or more segments will require the least amount of energy for the vehicle to reach its desired destination. The vehicle can also adjust the operation of one or more vehicle components based on the type of environment that the vehicle is in, the vehicle's speed, the traffic around the vehicle, route information, and/or energy characteristics about the vehicle.

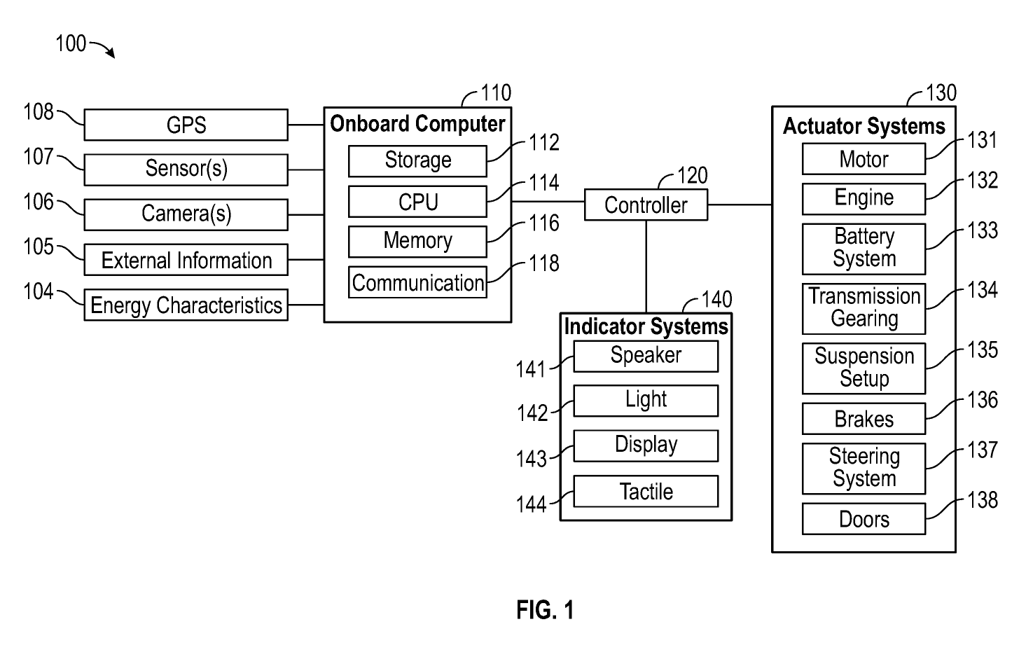

FIG. 1 illustrates an exemplary system block diagram of vehicle control system 100 according to examples of the disclosure. Vehicle control system 100 can perform any of the methods described with reference to FIGS. 2-5. Vehicle control system 100 can be incorporated into a vehicle, such as a consumer automobile. Other examples of vehicles that may incorporate the vehicle control system 100 include, without limitation, airplanes, boats, or industrial automobiles. Vehicle control system 100 can include one or more cameras 106 for determining various characteristics of the vehicle's surroundings, as described below with reference to FIGS. 2-5. Vehicle control system 100 can also include one or more other sensors 107 (e.g., radar, ultrasonic, laser, LIDAR, accelerometer, gyroscope, or speed) and a Global Positioning System (GPS) receiver 108 for detecting various characteristics about the vehicle and about the vehicle's surroundings. In some examples, sensor data can be fused together. This fusion can occur at one or more electronic control units (ECUs) (not shown). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance. Vehicle control system 100 can also receive (e.g., via an internet connection) external information such as map, route, destination, and/or traffic information from other vehicles or from an internet source via an external information interface 105 (e.g., a cellular Internet interface or a Wi-Fi Internet interface). Vehicle control system 100 can also include energy characteristics interface 104 capable of determining one or more characteristics about the vehicle's battery (e.g., the battery's remaining charge). Vehicle control system 100 can include an on-board computer 110 that is coupled to cameras 106, sensors 107, GPS receiver 108, external information interface 105, and energy characteristics interface 104, and that is capable of receiving the image data from the cameras and/or outputs from the sensors 107, the GPS receiver 108, the external information interface 105, and the energy characteristics interface 104. On-board computer 110 can include storage 112, memory 116, communications interface 118, and a processor 114. Processor 114 can perform any of the methods described with references to FIGS. 2-5. Additionally, communications interface 118 can perform any vehicle communications. Moreover, storage 112 and/or memory 116 can store data and instructions for performing any of the methods described with references to FIGS. 2-5. Storage 112 and/or memory 116 can be any non-transitory computer-readable storage medium, such as a solid-state drive or a hard disk drive, among other possibilities. The vehicle control system 100 can also include a controller 120 capable of controlling one or more aspects of vehicle operation, such as performing autonomous or semi-autonomous driving maneuvers and/or adapting vehicle operations as described below with references to FIGS. 2-5.

In some examples, vehicle control system 100 can be connected (e.g., via controller 120) to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Vehicle control system 100 can control, via controller 120, one or more of these actuator systems 130 during vehicle operation; for example, to open or close one or more of the doors of the vehicle using the door actuator system 138, to control the vehicle during autonomous driving operations, using the motor 131 or engine 132, battery system 133, transmission gearing 134, suspension setup 135, brakes 136, and/or steering system 137, etc. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle), and one or more tactile actuators 144 in the vehicle (e.g., as part of a steering wheel or seat in the vehicle). Vehicle control system 100 can control, via controller 120, one or more of these indicator systems 140 to provide indications to a driver.

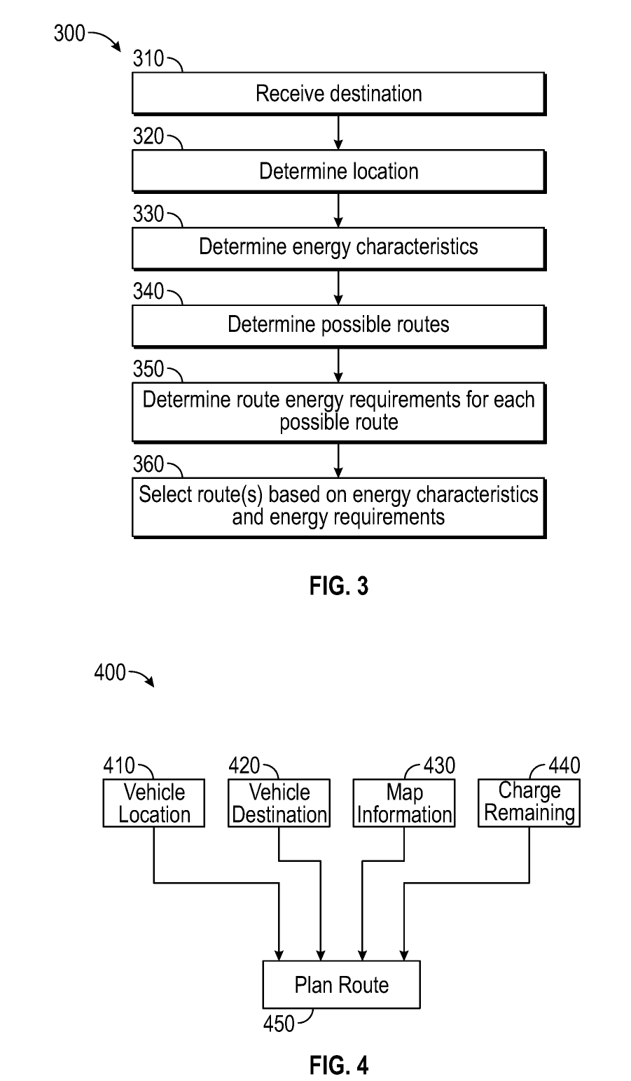

FIG. 2 illustrates an exemplary vehicle 200 determining possible routes 210 and 220 using map 250 according to examples of the disclosure. Point 202 can represent the current location of vehicle 200, and point 204 can represent the vehicle's desired destination. Possible routes 210 and 220 can comprise of segments of map 250 (e.g., segments 211-217 and 221-217, respectively). Each segment of map 250 (not all segments shown) can contain the estimated energy requirements for the vehicle to travel along that segment (e.g., the amount of energy that will likely be used by vehicle 200 to travel along that segment). In this way, vehicle 200 can determine one or more possible routes by combining of one or more segments for each possible route. For example, vehicle 200 can combine the one or more segments of map 250 that will form the shortest path to point 204. In another example, vehicle 200 can look up traffic information from an external source (e.g., another vehicle and/or an internet source) to combine the one or more segments of map 250 that will form the quickest route to point 204 (e.g., combine the one or more segments with the least traffic). In some examples, vehicle 200 can generate one or more possible routes by selecting different combinations of one or more segments of map 250 that will lead to point 204. In this way, vehicle 200 can determine and select an efficient combination of one or more segments for its route. For example, segment 211 can require the vehicle to use 40 watt-hours (Wh), segment 212 can require 50 Wh, segment 213 can require 50 Wh, segment 214 can require 40 Wh, segment 215 can require 20 Wh, segment 216 can require 10 Wh, and segment 217 can require 30 Wh, which would require the vehicle to use 240 Wh to travel along route 210. However, each of segments 221-217 can require 30 Wh, which would require the vehicle to use only 210 Wh to travel along route 220. Vehicle 200 can select to drive along route 220 to conserve energy, especially if vehicle 200 has a low remaining charge in its battery. In some examples, vehicle 200 can select to drive along route 220 if that route is faster than route 220. In some examples, vehicle 200 can allow a user to select either route 210 or route 220 (e.g., as described below with reference to FIGS. 3-4).

In some examples, route 210 can require more energy than route 220 because route 210 can require vehicle 200 to drive up and down a hill, whereas route 220 can be along a flat terrain. For example, segments 211-214 can represent the portion of route 210 that require vehicle 200 to drive uphill (e.g., requiring more energy), segments 215-16 can represent the portion of route 210 that require vehicle 200 to drive downhill (e.g., requiring less energy), and segment 217 can represent the portion of route 210 that is flat. In other examples, segments 211-214 can require more energy than other segments because that portion of the map may contain more traffic lights and/or traffic signs (e.g., stop signs) that could require vehicle 200 to decelerate and accelerate often. In some examples, segments 211-214 can require more energy than other segments because that portion of the map may require a higher speed limit (e.g., requiring more energy to accelerate and/or more sensor processing power) and/or have more vehicle and/or pedestrian traffic (e.g., requiring more sensor processing power). In some examples, the map segments can represent blocks (e.g., one or more blocks or portions of blocks), predetermined distances (e.g., 100 yards, half a mile, a mile, or 5 miles), highways (or a portion of a highway), freeways (or a portion of a freeway), and/or other routes on a map. In this way, a vehicle can use this information to plan routes within a neighborhood, a city, a county, a state, a country, and/or any other geographic region.

In some examples, map 250 (including segment energy requirements) can be a highly detailed or high-definition map (HD map). In some examples, segment data (including energy requirements) can be stored separately from the map in a data structure (e.g., a database, a hash table, a binary search tree, a data file, an XML file, or a binary decision diagram). In this way, estimated energy requirements for one or more segments (e.g., a route) can be determined by performing a data structure look up of those one or more segments (e.g., a database look up by segment coordinates). In some examples, map 250 and/or the data structure of segments can be stored remotely (e.g., remote database(s) and/or cloud services), and vehicle 200 can perform the map and/or data structure look up wirelessly (e.g., through a Wi-Fi connection or cellular connection). In some examples, the map or data structure can be updated by the vehicle and/or other vehicles (e.g., after driving along a particular segment), a driver, a system administrator, and/or any other person. In this way, a comprehensive data structure of estimated energy requirements can be maintained and shared among many vehicles.

In various embodiments, machine learning (e.g., deep learning and/or neural networks) may be implemented to improve estimated amounts of power used during a particular route or portion of a route. In some embodiments, a determination of energy efficiency during a current section of a trip/route may use less energy than predicted (e.g., segment 211 may use 50 Wh instead of 40 Wh, and segment 212 may use 60 Wh instead of 50 Wh). In such a case, future predictions of an amount of energy used may be modified. Such data can be uploaded to a cloud for further refining the energy requirement model to augment the charge estimate provided by a battery management system.

FIG. 3 illustrates an exemplary process 300 for determining one or more routes based on vehicle energy characteristics and estimated energy requirements according to examples of the disclosure. In some examples, process 300 can be invoked by a user manually through a control system such as a button, a touch screen, a voice command, a computer, a smartphone, or any device or system that allows user input to be entered. In some examples, process 300 can be performed continuously or repeatedly by the vehicle during driving procedures. In some examples, process 300 can be performed while the vehicle is in any driving mode (e.g., in an automated driving mode, an assisted driving mode, or a manual driving mode). For example, the vehicle can be operating in an automated driving mode (e.g., driving autonomously without user input), in an assisted driving mode (e.g., allowing automated driving operations such as automatically changing lanes, slowing down, pulling over, or any other automated driving operation), or in a manual driving mode (e.g., a driver controlling all driving operations) when process 300 is performed.

At step 310, process 300 receives the vehicle's desired destination. In some examples, a user can manually enter a desired destination through a control system such as a button, a touch screen, a voice command, a computer, a smartphone, or any device or system that allows user input to be entered. At step 320, process 300 can determine the vehicle's location through GPS receivers, cameras, ultrasonic sensors, radar sensors, LIDAR sensors, cellular positioning systems, maps, cloud services, landmark positions, and any other systems or sensors that can be used to determine a vehicle's location. In some examples, a user can manually enter the vehicle's location through a control system such as a button, a touch screen, a voice command, a computer, a smartphone, or any device or system that allows user input to be entered.

At step 330, process 300 can detect one or more energy characteristics of the vehicle. For example, process 300 can determine the remaining charge of the vehicle's battery (e.g., through known methods for determining a battery's remaining charge). In some examples, process 300 can detect one or more issues with the vehicle's battery (e.g., efficiency of an inverter (how much power is lost when converting DC battery power to AC power), the efficiency of power transferred from the inverter to the transmission to other vehicle components, low maximum charge, slow charge, or quick discharge) at step 330. In some example, the vehicle can be configured with one or more battery strings (e.g., an interconnected string of one or more batteries as described in U.S. Provisional Patent Application No. 62/249,136, for example).

At step 340, process 300 can determine possible driving routes (e.g., through known route planning techniques). For example, process 300 can determine possible routes using a map, a vehicle navigation system, and/or an external source (e.g., an internet source). For instance, process 300 can look up map information from a map that is partitioned into segments (e.g., partitioned by blocks, set distances, streets, highways, freeways, and/or other routes) to select one or more combinations of segments to form one or more possible routes to the desired destination (e.g., as described above with reference to FIG. 2). In some examples, process 300 can determine multiple routes such as a route with the shortest distance to the destination, a route that avoids highways, a route that will take the shortest amount of time, a scenic route, and/or any other route.

At step 350, process 300 can determine the estimated energy requirements for each possible route from step 340. For example, process 300 can look up the estimated energy required to drive through each segment (e.g., perform a local and/or remote data structure look up of the segment) of each possible route. Process 300 can then add up the estimated energy required for each segment of each route to determine the total estimated energy required for the vehicle to drive that particular route. In some examples, the estimated energy required for each segment of each route may already be stored within the map used to determine the routes at step 340. In that instance, process 300 can simply add up the estimated energy required for each segment of each route (e.g., without having to perform a separate data structure look up for each segment).

At step 360, process 300 can select one or more routes based on the energy characteristics of the vehicle determined at step 330 and the estimated energy requirements of the possible routes determined at step 350. For example, process 300 can determine that the vehicle has a remaining charge of 500 Wh at step 330, that the estimated energy required for a first possible route is 400 Wh, that the estimated energy required for a second possible route is 450 Wh, and that the estimated energy required for a third possible route is 525 Wh at step 350. Process 300 can then select the first and/or the second possible route at step 360 because the vehicle would not have enough charge to drive along the third possible route. In some examples, process 300 can display the selected possible route options through the vehicle's one or more display systems (e.g., control panel, entertainment system, heads up display system, or infotainment system), or through a computer, smartphone, and/or any other electronic device associated with the user. In some examples, the user can select a route through a control system such as a button, a touch screen, a voice command, a computer, a smartphone, or any device or system that allows user input to be entered.

FIG. 4 illustrates an exemplary process 400 for planning a route according to examples of the disclosure. In some examples, process 400 can be performed continuously or repeatedly by the vehicle during driving procedures. In some examples, process 400 can be invoked by a user manually through a control system such as a button, a touch screen, a voice command, a computer, a smartphone, or any device or system that allows user input to be entered. In some examples, process 400 can be performed while the vehicle is in any driving mode (e.g., in an automated driving mode, an assisted driving mode, or a manual driving mode).

At step 410, process 400 can determine the vehicle's current location through GPS receivers, cameras, ultrasonic sensors, radar sensors, LIDAR sensors, cellular positioning systems, maps, cloud services, landmark positioning, and any other systems or sensors that can be used to determine a vehicle's location (e.g., as described above with reference to FIG. 3). At step 420, process 400 can receive the desired destination through a control system such as a button, a touch screen, a voice command, a computer, a smartphone, or any device or system that allows user input to be entered (e.g., as described above with reference to FIG. 3).

At step 430, process 400 can receive map information. In some examples, the map information can be stored locally or remotely (e.g., as described above with reference to FIGS. 2-3). The map information can contain detailed information about roads, highways, freeways, landmarks, buildings, etc. (e.g., the map information can be from an HD map). The map information can be partitioned into segments, and each segment can include information about the amount of energy needed for the vehicle to travel along that particular segment of the map (e.g., as described above with reference to FIGS. 2-3). At step 440, process 400 can determine the charge remaining on the vehicle (e.g., as described above with to FIGS. 2-3). In some examples, steps 410-440 can be performed concurrently or in any sequence.

At step 450, process 450 can plan a route based on inputs from steps 410-440. For example, a user can enter a desired destination at step 420, and process 400 can determine the vehicle's location at step 410, receive map information that includes the current location and the desired destination at step 430, and determine that the remaining charge is 1000 Wh. Using this information, process 450 can determine one or more possible routes that will require less than 1000 Wh at step 450 (e.g., as described above with reference to FIGS. 2-3). In some examples, process 400 can then automatically select one route out of the one or more possible routes at step 450. In some examples, process 400 can calculate the time until the next charge by factoring the amount of energy the vehicle will use to drive the selected route at step 450.

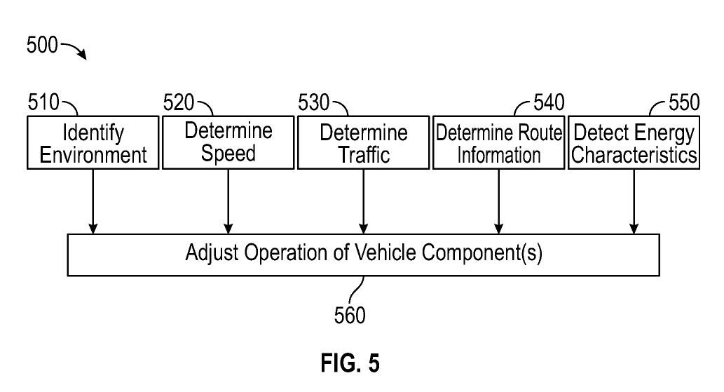

In some examples, the route that process 400 automatically selects at step 450 can depend on user preferences. For example, a user can set preferences for process 400 to always select the route that uses the least energy, the route that takes the shorted amount of time, the route that has the shortest distance, the route that avoids highways, the scenic route, or a route in accordance with any other user preferences. In some examples, user preferences can be entered by the user through a control system such as a button, a touch screen, a voice command, a computer, a smartphone, or any device or system that allows user input to be entered. In some examples, a vehicle can operate in one or more energy modes of operation, and the route that process 400 automatically selects can depend on the current energy mode of operation. For example, a vehicle can operate in a conservation mode (e.g., where process 400 is configured to always select the route that uses the least amount of energy) or in a performance mode (e.g., where process 400 is configured to always select the route that takes the least amount of time). The vehicle can also operate in an interactive mode in which process 400 allows the user to choose a route from the one or more potential routes (e.g., as described above with reference to FIG. 3). In some examples, the conservation mode can be configured to accelerate slowly and to use regenerative braking to slow down to conserve energy. In some examples, the conservation mode can also adjust the operation of vehicle components to conserve energy as discussed below with reference to FIG. 5. In some examples, the performance mode can be configured to accelerate quickly so as to always be driving at or around the speed limit. In this way, a vehicle operating in the performance mode can attempt to reach its destination as quickly as possible.

In some examples, process 400 can suggest alternative routes and/or destinations. For example, a user can enter a grocery store that is five miles away as the desired destination at step 420, and process 400 can determine the vehicle's location at step 410, receive map information that includes the current location and the desired destination at step 430, and determine that the remaining charge is 1000 Wh. Using this information, process 450 can determine that all of the possible routes that will require more than 1000 Wh at step 450. Process 400 can then look up a charging station along the possible one or more routes, and suggest that the vehicle stop at the charting station along the way to its desired destination. In other examples, process 400 can look up an alternative grocery store using the map information or an external source (e.g., an internet source), and determine one or more routes to that alternative destination. In this way, process 400 can find a route to a different grocery store that the vehicle can reach with its remaining charge and suggest the alternative destination to the user. For example, process 400 can find an alternative grocery store that is two miles away and determine a possible route that only requires 600 Wh for the vehicle to reach it. In some examples, process 400 can suggest the alternative destination(s) and/or alternative route(s) through the vehicle's one or more display systems (e.g., control panel, entertainment system, heads up display system, or infotainment system), or through a computer, smartphone, and/or any other electronic device associated with the user. In some examples, a user can confirm or reject the alternative destination and/or route through a control system such as a button, a touch screen, a voice command, a computer, a smartphone, or any device or system that allows user input to be entered.

In some examples, process 400 can suggest possible destinations and/or possible routes to those suggested destinations. For example, a user can enter a general destination at step 420, and process 400 can suggest possible destinations and/or one or more possible routes to those possible destinations at step 450. For example, a user can enter “beach” as the destination at step 420, and process 400 can determine the vehicle's current location at step 410, look up map information that includes the vehicle's current location and beach information at step 430, and determine the vehicle's remaining charge at step 440. At step 450, process 400 can then determine one or more possible routes to one or more beaches that the vehicle can reach with its remaining charge (e.g., as described above with reference to FIGS. 2-3). In some examples, process 400 can display the one or more possible routes to one or more beaches through the vehicle's one or more display systems (e.g., control panel, entertainment system, heads up display system, or infotainment system), or through a computer, smartphone, and/or any other electronic device associated with the user. In some examples, the user can select one of the suggested beach destinations through a control system such as a button, a touch screen, a voice command, a computer, a smartphone, or any device or system that allows user input to be entered. In some examples, the vehicle can store additional information about the user such as the user's home address, age, driving patterns (e.g., venues visited, the frequency of the visits, and the days and times of the visits), and any other information entered by the user. In some examples, a driving pattern can be detected by logging the origin, the route, the destination, and the date and time of each trip taken by a user. This logged information can then be analyzed by performing internet searches on the addresses of frequent destinations (e.g., to determine the destination's type of business). With this information, process 450 can suggest possible destinations to the user (e.g., activities for the user). For example, a user's driving patterns can show that the user frequents a sushi restaurant every Friday for lunch. Upon recognizing the user's Friday lunch driving patterns, process 400 can automatically be run with the vehicle destination of “sushi” (e.g., as described above). In this way, process 400 can suggest a new sushi restaurant to the user. In some examples, the driving patterns of other users can be monitored to determine popular destinations. For example, a popular sushi restaurant can be determined by analyzing the driving patterns of other users that frequent sushi restaurants. In some examples, this determination can be limited to users of the same age. In this way, process 400 can suggest a popular sushi restaurant that the user may enjoy.

FIG. 5 illustrates an exemplary process 500 for adjusting the operation of vehicle components to conserve energy according to examples of the disclosure. In some examples, process 500 can be performed continuously or repeatedly by the vehicle during driving procedures. In some examples, process 500 can be invoked by a user manually through a control system such as a button, a touch screen, a voice command, a computer, a smartphone, or any device or system that allows user input to be entered. In some examples, process 500 can be performed while the vehicle is in any driving mode (e.g., in an automated driving mode, an assisted driving mode, or a manual driving mode) (e.g., as described above with reference to FIGS. 3-4). In some examples, process 500 can be performed while the vehicle is in any energy modes of operation (e.g., as described above with reference to FIG. 4).

At step 510, process 500 can identify the type of environment of where the vehicle is currently located according to examples of the disclosure. For example, process 500 can determine the vehicle's current location through GPS receivers, cameras, ultrasonic sensors, radar sensors, LIDAR sensors, cellular positioning systems, maps, cloud services, landmark positioning, and any other systems or sensors that can be used to determine a vehicle's location (e.g., as described above with reference to FIGS. 3-4) and look up map information about that location. The map information can include whether the current environment is a rural area, an urban area, a suburban area, or any other information about the current location. In some examples, the map information can be stored locally or remotely (e.g., as described above with reference to FIGS. 2-4). In some examples, process 500 can identify the type of environment by processing data from the vehicle's one or more sensors. For example, the vehicle can include various sensors for determining one or more characteristics about the vehicle's surroundings (e.g., as described above with reference to FIG. 1). These sensors can include cameras, radar sensors, ultrasonic sensors, laser sensors, LIDAR sensors, or any other sensors that can be used to detect one or more characteristics about the vehicle's surroundings. These sensors can be configured on the vehicle to provide it with 360 degree (or other) coverage of the area surrounding the vehicle. Process 500 can process data from one or more of these sensors (e.g., one or more cameras) to determine one or more characteristics about the vehicle's environment at step 510. Process 500 can then determine whether the vehicle is in a rural area if it does not detect any buildings or houses, in an urban area if it detects one or more buildings but does not detect any houses, or in a suburban area if it detects one or more houses at step 510. In some examples, process 500 can detect buildings and/or houses through known pattern matching techniques. In some examples, process 500 can update a map with its environmental classification at step 510. In this way, the vehicle can simply perform a map look up. In some examples, the map can be stored locally and/or remotely. In some examples, the map can be updated by other vehicles. In this way, a comprehensive map can be maintained and shared among many vehicles.

At step 520, process 500 can determine the vehicle's speed via one or more of the vehicle's sensors. For example, the vehicle can be equipped with one or more odometry sensors (e.g., speed sensors, GPS receivers, gyroscopes, accelerometers, or any other motion sensors), and process 500 can receive speed information from these one or more sensors at step 520.

At step 530, process 500 can determine one or more characteristics about the traffic around the vehicle. As described above, the vehicle can be equipped with one or more sensors that can be used to detect one or more characteristics about the vehicle's surroundings (e.g., cameras, radar sensors, ultrasonic sensors, laser sensors, LIDAR sensors, or any other sensors that can be used to detect one or more characteristics about the vehicle's surroundings). Process 500 can process data from these one or more sensors to identify one or more other vehicles and/or pedestrians around the vehicle (e.g., through known pattern recognition techniques) at step 530. In this way, process 500 can determine the number of other vehicles and/or pedestrians that are around the vehicle. In some examples, process 500 can also process data from one or more of the sensors to monitor the location, heading, speed, lights, or any other characteristics about these one or more vehicles and/or pedestrians at step 530. In some examples, process 500 can receive traffic information (e.g., the number of other vehicles and/or pedestrians around the vehicle) from an external source (e.g., another vehicle and/or an internet source).

At step 540, process 500 can determine one or more characteristics about the vehicle's current route. For example, process 500 can look up map information for the current route to determine whether the vehicle is currently on a road, highway, or freeway; to determine the curvature, incline, decline and/or any other information about the road, highway, or freeway; to determine whether that are any upcoming traffic lights or traffic signs (e.g., stop signs, yield signs, or lane ending signs); and/or to determine any upcoming turn, U-turn, or any other upcoming driving maneuvers.

At step 550, process 500 can determine the vehicle's energy characteristics. For example, process 500 can determine the remaining charge of the vehicle's battery (e.g., as described above with to FIGS. 2-4). In some examples, steps 510, 520, 530, 540, and 550 can be performed in any order. In some examples, steps 510-550 can be performed concurrently or in any sequence. In some examples, one or more of steps 510-550 can be optional.

At step 560, process 500 can adjust the operation of vehicle components based on inputs from one or more of steps 510, 520, 530, 540, and/or 550. Various components of a vehicle can be deactivated or their operation level can be adjusted to save power including, but not limited to: sensors, portions of an HVAC system (e.g., interior air conditioning may be deactivated to conserve resources used to cool a battery), portions of a system that cools a battery, etc. Further, the amount of energy used by an HVAC system can be adjusted based on the section of the trip where the vehicle is located (e.g., the energy consumed by the HVAC system may be reduced if the vehicle is close to its destination (e.g., within 2, 5, or 10 minutes from its destination). As one example, process 500 can adjust the operation of vehicle components at step 560 by reducing the sampling rate of the vehicles sensors (e.g., from 30 Hz to 5 Hz) if process 500 determines that the vehicle is in a rural area at step 510. In another example, process 500 can adjust the operation of vehicle components at step 560 by taking some sensors offline (e.g., taking one or more cameras offline and relying on radar, LIDAR, and/or any other sensors that require less energy to monitor) if process 500 determines that the vehicle is in a rural area at step 510 and that no other vehicles or pedestrians are around the vehicle (or the vehicle only detects a vehicle every few minutes) at step 530. In another example, process 500 can adjust the operation of vehicle components at step 560 by reducing the sampling rate of the vehicles sensors if process 500 determines that the car is traveling below a speed threshold (e.g., below 25, 30, or 35 miles per hour) at step 520. In another example, process 500 can adjust the operation of vehicle components by taking some sensors offline and/or reducing the sampling rate of the vehicles sensors if process 500 determines that the vehicle is driving in a straight line for a threshold distance (e.g., for one or more miles). For example, process 500 can take one or more cameras offline and rely on radar and LIDAR for the stretch of the route that the vehicle is traveling in a straight line at step 560. In another example, process 500 can take all of the vehicle's cameras offline with the exception of any forward-facing cameras while the vehicle is traveling in a straight line. In some examples, process 500 can return all of the vehicle's sensors online and/or increase thee sensor sampling rate if another vehicle and/or a pedestrian is detected. In this way, process 500 can help avoid an accident.

In some examples, process 500 can maximize (or increase) the operation of the vehicle's sensors (e.g., operate the vehicle's sensors at or near capacity) when the vehicle is an urban or suburban area (e.g., to avoid a collision with an unforeseen vehicle or pedestrian), when the vehicle is going equal to or above a speed threshold (e.g., equal to or above 35, 40, 50 miles per hour or any other speed that would require a faster reaction time), when one or more other vehicles and/or pedestrians (or more than any predetermined number of other vehicles or pedestrians) are around the vehicle, when the vehicle is approaching a traffic light, and/or when the current route contains many upcoming curves and/or contains many blind spots (e.g., to avoid an accident).

In some examples, the vehicle can lower the vehicle's sensor sampling rate when the vehicle's remaining charge falls below a certain threshold (e.g., less than 30, 20%, or 10% of the vehicle's energy capacity). In some examples, the vehicle may dim its internal lights and/or its external lights if the vehicle's charge falls below a certain threshold (e.g., less than 30, 20%, or 10% of the vehicle's energy capacity). In some examples, process 500 can use GPS information for tactical control (e.g., instead of other sensor input).

Thus, the examples of the disclosure provide various ways to optimize energy consumption in vehicles.

Therefore, according to the above, some examples of the disclosure are directed to a system comprising: one or more sensors; one or more batteries; one or more processors coupled to the one or more sensors; and a memory including instructions, which when executed by the one or more processors, cause the one or more processors to perform a method comprising: receiving a desired destination; determining a current location of a vehicle via the one or more sensors; detecting one or more energy characteristics about the one or more batteries via the one or more sensors; determining one or more possible routes to the desired destination; determining route energy requirements for each of the one or more possible routes; and selecting one or more routes based on the one or more energy characteristics about the one or more batteries and the route energy requirements. Additionally or alternatively to one or more of the examples disclosed above, in some examples, detecting one or more energy characteristics about the one or more batteries comprises determining a remaining charge of the one or more batteries. Additionally or alternatively to one or more of the examples disclosed above, in some examples, selecting the one or more routes based on the one or more energy characteristics about the one or more batteries and the route energy requirements comprises: selecting the one or more possible routes with route energy requirements that are less than the remaining charge of the one or more batteries. Additionally or alternatively to one or more of the examples disclosed above, in some examples, selecting one or more routes based on the one or more energy characteristics about the one or more batteries and the route energy requirements comprises: determining that the one or more possible routes all require more energy than the remaining charge of the one or more batteries; and in response to the determination that the one or more possible routes all require more energy than the remaining charge of the one or more batteries: determining one or more alternative destinations; and determining one or more possible routes to the one or more alternative destinations. Additionally or alternatively to one or more of the examples disclosed above, in some examples, determining one or more possible routes to the desired destination comprises: looking up map information, wherein the map information is partitioned into segments; and combining one or more segments from the current location to the desired destination. Additionally or alternatively to one or more of the examples disclosed above, in some examples, combining the one or more segments from the current location to the desired destination comprises combining the one or more segments that form the shortest path to the desired destination. Additionally or alternatively to one or more of the examples disclosed above, in some examples, combining the one or more segments from the current location to the desired destination comprises: looking up traffic information associated with the map information; and combining the one or more segments with the least traffic. Additionally or alternatively to one or more of the examples disclosed above, in some examples, determining one or more possible routes to the desired destination comprises using a vehicle navigation system. Additionally or alternatively to one or more of the examples disclosed above, in some examples, selecting the one or more routes based on the one or more energy characteristics and the route energy requirements comprises selecting the one or more possible routes with the least route energy requirements. Additionally or alternatively to one or more of the examples disclosed above, in some examples, selecting the one or more routes based on the one or more energy characteristics and the route energy requirements comprises determining a current energy mode of operation from one or more energy modes of operation, wherein in the one or more energy modes of operation comprise: a conservation mode; a performance mode; and an interactive mode. Additionally or alternatively to one or more of the examples disclosed above, in some examples, in accordance with a determination that the current mode of operation is the conservation mode, selecting the one or more possible routes that require the least energy. Additionally or alternatively to one or more of the examples disclosed above, in some examples, in accordance with a determination that the current mode of operation is the performance mode, selecting the one or more possible routes that take the least amount of time. Additionally or alternatively to one or more of the examples disclosed above, in some examples, in accordance with a determination that the current mode of operation is the interactive mode, allowing a user to select the one or more possible routes.

Some examples of the disclosure are directed to a non-transitory computer-readable medium including instructions, which when executed by one or more processors, cause the one or more processors to perform a method comprising: receiving a desired destination; determining a current location of a vehicle via the one or more sensors; detecting one or more energy characteristics about one or more batteries via one or more sensors; determining one or more possible routes to the desired destination; determining route energy requirements for each of the one or more possible routes; and selecting one or more routes based on the one or more energy characteristics about the one or more batteries and the route energy requirements.

Some examples of the disclosure are directed to a vehicle comprising: one or more sensors; one or more batteries; one or more processors coupled to the one or more sensors; and a memory including instructions, which when executed by the one or more processors, cause the one or more processors to perform a method comprising: receiving a desired destination; determining a current location of the vehicle via the one or more sensors; detecting one or more energy characteristics about the one or more batteries via the one or more sensors; determining one or more possible routes to the desired destination; determining route energy requirements for each of the one or more possible routes; and selecting one or more routes based on the one or more energy characteristics about the one or more batteries and the route energy requirements.

Some examples of the disclosure are directed to a method comprising: receiving a desired destination; determining a current location of a vehicle via the one or more sensors; detecting one or more energy characteristics about one or more batteries via one or more sensors; determining one or more possible routes to the desired destination; determining route energy requirements for each of the one or more possible routes; and selecting one or more routes based on the one or more energy characteristics about the one or more batteries and the route energy requirements.

Some examples of the disclosure are directed to a system comprising: one or more sensors; one or more batteries; one or more processors coupled to the one or more sensors; and a memory including instructions, which when executed by the one or more processors, cause the one or more processors to perform a method comprising: determining a speed of a vehicle; identifying an environment type surrounding the vehicle; determining traffic around the vehicle; determining route information; detecting one or more energy characteristics about the one or more batteries via the one or more sensors; and adjusting an operation of one or more vehicle components based on the speed or the vehicle, the environment type, the traffic around the vehicle, the route information, or the one or more energy characteristics.

Some examples of the disclosure are directed to a non-transitory computer-readable medium including instructions, which when executed by one or more processors, cause the one or more processors to perform a method comprising: determining a speed of a vehicle; identifying an environment type surrounding the vehicle; determining traffic around the vehicle; determining route information; detecting one or more energy characteristics about one or more batteries via one or more sensors; and adjusting an operation of one or more vehicle components based on the speed or the vehicle, the environment type, the traffic around the vehicle, the route information, or the one or more energy characteristics.

Some examples of the disclosure are directed to a method comprising: determining a speed of a vehicle; identifying an environment type surrounding the vehicle; determining traffic around the vehicle; determining route information; detecting one or more energy characteristics about one or more batteries via one or more sensors; and adjusting an operation of one or more vehicle components based on the speed or the vehicle, the environment type, the traffic around the vehicle, the route information, or the one or more energy characteristics.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
one or more sensors;
one or more batteries;
one or more processors coupled to the one or more sensors; and
a memory including instructions, which when executed by the one or more processors, cause the one or more processors to perform a method comprising:
receiving a desired destination;
determining a current location of a vehicle via the one or more sensors;
detecting one or more energy characteristics about the one or more batteries via the one or more sensors;
determining one or more possible routes to the desired destination;
determining route energy requirements for each of the one or more possible routes; and
selecting one or more routes based on the one or more energy characteristics about the one or more batteries and the route energy requirements.

2. The system of claim 1, wherein detecting one or more energy characteristics about the one or more batteries comprises determining a remaining charge of the one or more batteries.

3. The system of claim 2, wherein:
selecting the one or more routes based on the one or more energy characteristics about the one or more batteries and the route energy requirements comprises:
selecting the one or more possible routes with route energy requirements that are less than the remaining charge of the one or more batteries.

4. The system of claim 2, wherein:
selecting one or more routes based on the one or more energy characteristics about the one or more batteries and the route energy requirements comprises:
determining that the one or more possible routes all require more energy than the remaining charge of the one or more batteries; and
in response to the determination that the one or more possible routes all require more energy than the remaining charge of the one or more batteries:
determining one or more alternative destinations; and
determining one or more possible routes to the one or more alternative destinations.

5. The system of claim 1, wherein:
determining one or more possible routes to the desired destination comprises:
looking up map information, wherein the map information is partitioned into segments; and
combining one or more segments from the current location to the desired destination.

6. The system of claim 5, wherein combining the one or more segments from the current location to the desired destination comprises combining the one or more segments that form the shortest path to the desired destination.

7. The system of claim 5, wherein combining the one or more segments from the current location to the desired destination comprises:
looking up traffic information associated with the map information; and
combining the one or more segments with the least traffic.

8. The system of claim 1, wherein determining one or more possible routes to the desired destination comprises using a vehicle navigation system.

9. The system of claim 1, wherein selecting the one or more routes based on the one or more energy characteristics and the route energy requirements comprises selecting the one or more possible routes with the least route energy requirements.

10. The system of claim 1, wherein:
selecting the one or more routes based on the one or more energy characteristics and the route energy requirements comprises determining a current energy mode of operation from one or more energy modes of operation, wherein in the one or more energy modes of operation comprise:
a conservation mode;
a performance mode; and
an interactive mode.

11. The system of claim 10, wherein:
in accordance with a determination that the current mode of operation is the conservation mode, selecting the one or more possible routes that require the least energy.

12. The system of claim 10, wherein:
in accordance with a determination that the current mode of operation is the performance mode, selecting the one or more possible routes that take the least amount of time.

13. The system of claim 10, wherein:
in accordance with a determination that the current mode of operation is the interactive mode, allowing a user to select the one or more possible routes.

14. A vehicle comprising:
one or more sensors;
one or more batteries;
one or more processors coupled to the one or more sensors; and
a memory including instructions, which when executed by the one or more processors, cause the one or more processors to perform a method comprising:
receiving a desired destination;
determining a current location of the vehicle via the one or more sensors;
detecting one or more energy characteristics about the one or more batteries via the one or more sensors;
determining one or more possible routes to the desired destination;
determining route energy requirements for each of the one or more possible routes; and
selecting one or more routes based on the one or more energy characteristics about the one or more batteries and the route energy requirements.

15. A method comprising:
receiving a desired destination;
determining a current location of a vehicle via the one or more sensors;
detecting one or more energy characteristics about one or more batteries via one or more sensors;
determining one or more possible routes to the desired destination;
determining route energy requirements for each of the one or more possible routes; and
selecting one or more routes based on the one or more energy characteristics about the one or more batteries and the route energy requirements.
